(19) United States
(12) Patent Application Publication
(10) Pub. No.: US 2023/0401555 A1
(43) Pub. Date: Dec. 14, 2023

(54) SYSTEM AND METHOD FOR TRANSACTION ACCOUNT BASED MICRO-PAYMENTS

(71) Applicant: American Express Travel Related Services Company, Inc., New York, NY (US)

(72) Inventors: Alaric M. Eby, Chicago, IL (US); Andras L. Ferenczi, Peoria, AZ (US); Harish R. Naik, Phoenix, AZ (US); Vishnuvajhala Venkata Subrahmanyam, Phoenix, AZ (US)

(21) Appl. No.: 18/238,734

(22) Filed: Aug. 28, 2023

Related U.S. Application Data
(63) Continuation of application No. 16/051,126, filed on Jul. 31, 2018, now abandoned.

(51) Int. Cl. G06Q 20/22; H04L 9/06; G06Q 20/40; G06F 21/64

(52) U.S. Cl. CPC G06Q 20/29; H04L 9/0637; G06Q 20/401; G06F 21/64

(57) ABSTRACT

A transaction account based micro-payment system using blockchain is disclosed. The system may receive a micro-payment request including a payment address from a merchant system. The system may invoke an account holder account smart contract and a directory smart contract. The system may write a plurality of micro-payment transaction debits to a transaction account based micro-payment blockchain via a blockchain node. The system may generate a transaction clearance event based on the account holder account smart contract. The system may write a micro-payment transaction clearance credit to the transaction account based micro-payment blockchain.

### CLAIM OF PRIORITY

This application is a continuation application of and claims priority to U.S. application Ser. No. 16/051,126, filed on Jul. 31, 2018, entitled “SYSTEM AND METHOD FOR TRANSACTION ACCOUNT BASED MICRO-PAYMENTS,” which application is hereby incorporated herein by reference.

### FIELD

This disclosure generally relates to transaction account based micro-transactional purchases of items, and more particularly, to systems and methods for cross-platform reconciliation of transaction account based micro-transactions using a distributed ledger.

### BACKGROUND

A micro-transaction or micro-payment is a financial transaction involving a small sum of money such as for example, between a few dollars to fractions of a cent. However, traditional payment networks (e.g., transaction account payment networks) tend to have payment transaction costs which exceed the underlying value of the micro-payment. In this regard, traditional payment systems tend to make micro-payments impractical where the individual transaction cost exceeds the payment sum.

### SUMMARY

A system, method, and computer readable medium (collectively, the “system”) is disclosed for a transaction account based micro-payments using blockchain. The system may include an issuer system having a blockchain node configured to retrieve and write data to a transaction account based micro-payment blockchain. The issuer system may receive a micro-payment request including a payment address, wherein the payment address is associated with a merchant system. The issuer system may invoke an account smart contract and a directory smart contract. The issuer system may write a plurality of micro-payment transaction debits to a transaction account based micro-payment blockchain via a blockchain node. The issuer system may generate a transaction clearance event based on the account holder account smart contract. The issuer system may write a micro-payment transaction clearance credit to the transaction account based micro-payment blockchain.

In various embodiments, the issuer system may associate an account holder account and a transaction address of a transaction account based micro-payment wallet. The issuer system may generate the micro-payment account smart contract, wherein the account holder account, the transaction address, and the micro-payment account smart contract are associated on a one to one basis. The issuer system may write the micro-payment account smart contract to the transaction account based micro-payment blockchain via the blockchain node.

In various embodiments, generating the transaction clearance event may further comprise retrieving, by the issuer system, the plurality of micro-payment transaction debits via the blockchain node. The issuer system may determine an association between the plurality of micro-payment transaction debits and the account holder account based on the account holder account smart contract. The issuer system may aggregate the plurality of micro-payment transaction debits based on the association and generate an account holder debit transfer balance based on the aggregation of the plurality of micro-payment transaction debits. The issuer system may write the account holder debit transfer balance to an accounts receivable system as an account holder debit balance associated with the account holder account. The issuer system may generate the micro-payment transaction clearance credit based on the account holder debit balance.

In various embodiments, the account holder account smart contract comprises transaction clearance criteria, wherein the transaction clearance event is generated in response to the transaction clearance criteria. In various embodiments, the transaction clearance criteria comprise at least one of an individual micro-payment threshold, an aggregate micro-payment threshold, a transaction volume threshold, or a time based threshold.

In various embodiments, the issuer system may receive a merchant registration request. The issuer system may associate a merchant identifier and a merchant blockchain transaction address. The issuer system may generate the directory smart contract based on the merchant blockchain transaction address and merchant identifier association. The issuer system may write the directory smart contract to the transaction account based micro-payment blockchain via the blockchain node. In various embodiments, the issuer system may associate a merchant payable credit with the merchant identifier based on the account holder debit balance in response to the transaction clearance event.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

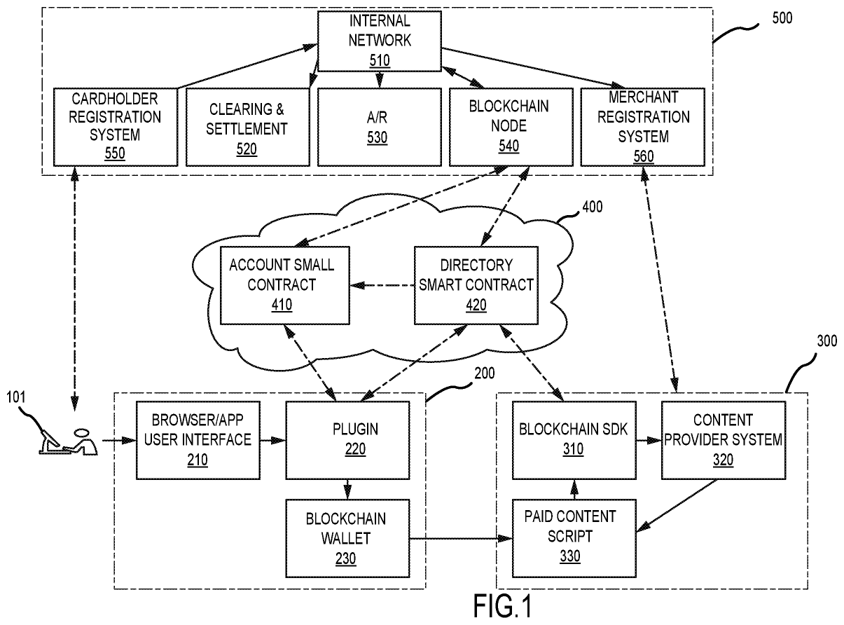

FIG. 1 is a block diagram illustrating a transaction account based micro-payment system, in accordance with various embodiments;

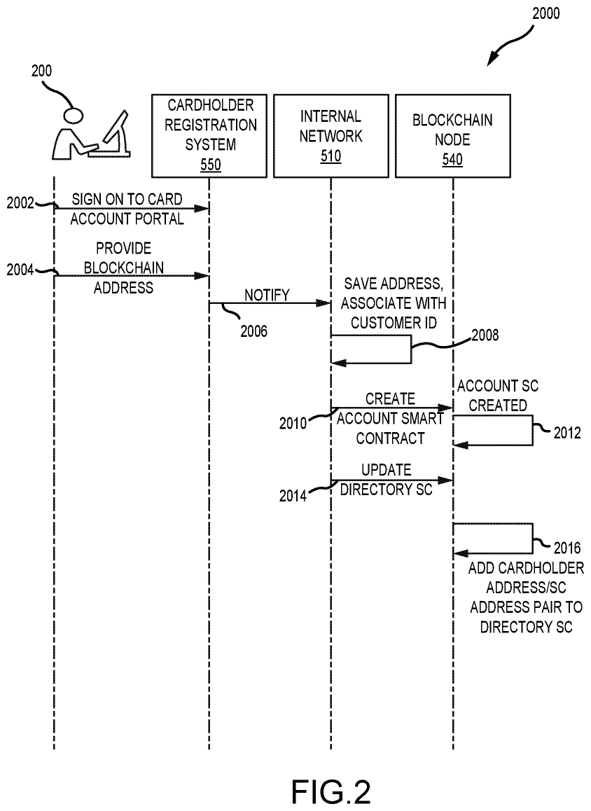

FIG. 2 illustrates a process flow for account holder registration in a transaction account based micro-payment system, in accordance with various embodiments;

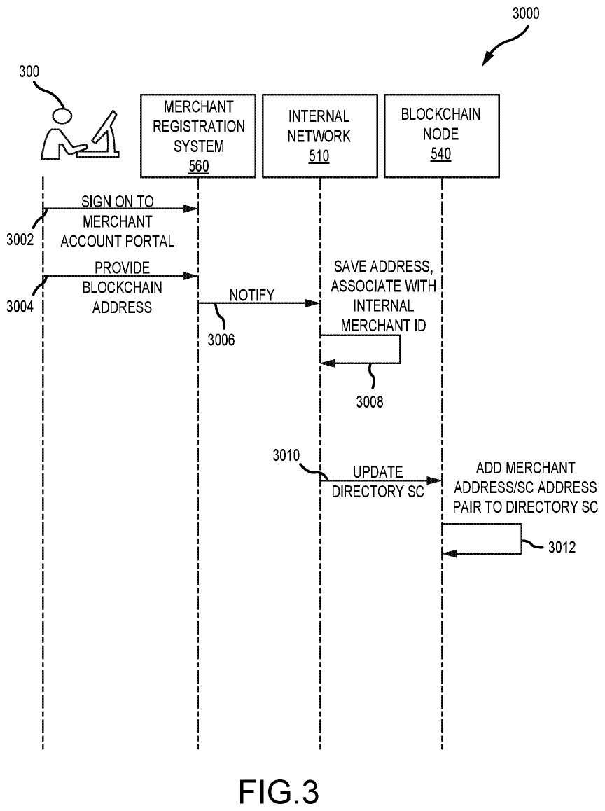

FIG. 3 illustrates a process flow for merchant registration in a transaction account based micro-payment system, in accordance with various embodiments;

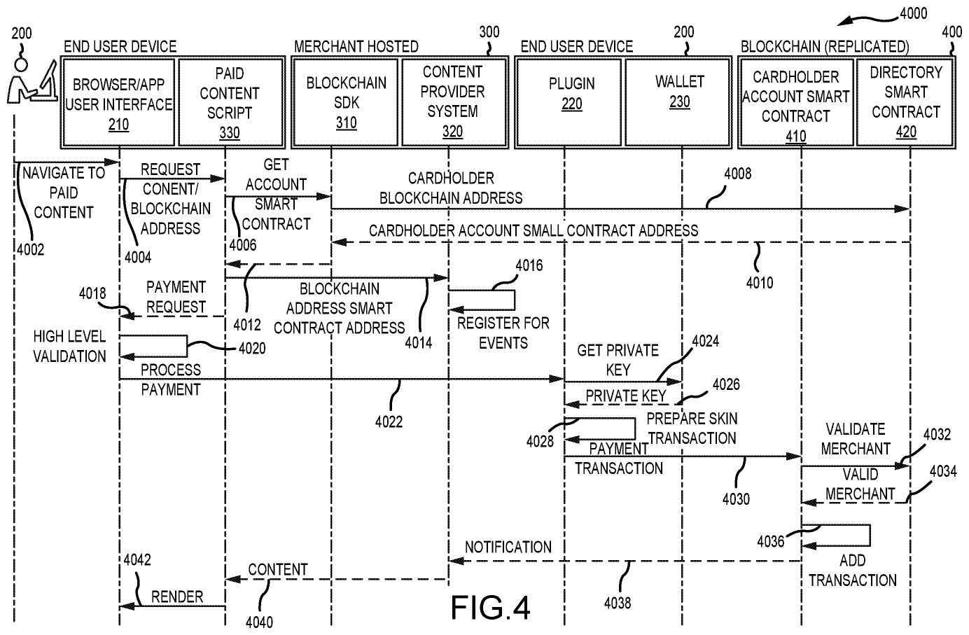

FIG. 4 illustrates a process flow for a transaction account based micro-payment system, in accordance with various embodiments; and

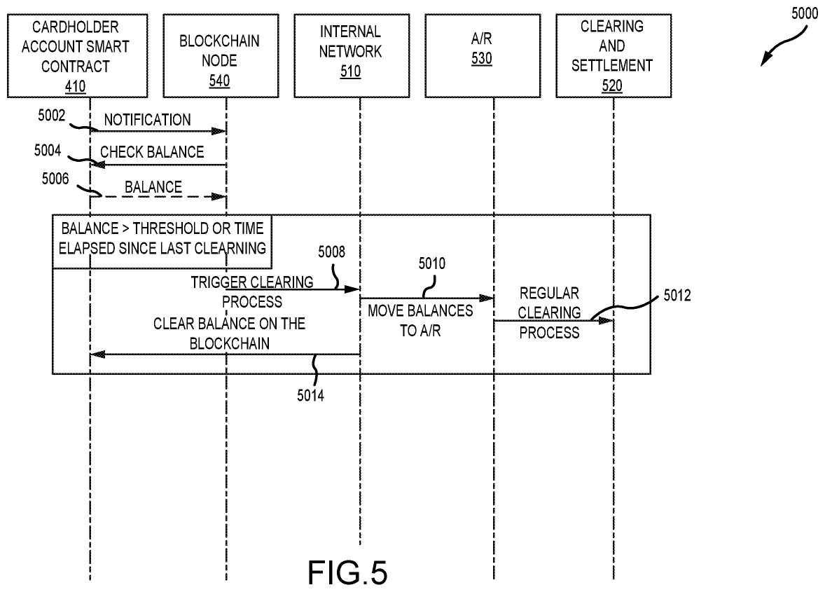

FIG. 5 illustrates a process flow for a transaction clearance event in a transaction account based micro-payment system, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The transaction account based micro-payment system may be used to facilitate merchant initiated transactions between an account holder and the merchant using a blockchain. The transaction account based micro-payment system may also connect the account holder to one or more merchants such as, for example, content providers or service providers. For example, a merchant may be a content provider posting content to a website via a content provider system. An account holder may browse the website via an account holder device comprising a browser that may be integrated with a blockchain network. In various embodiments, the merchant website may launch a content script which may request a micro-payment, for example, to access content (e.g., a paywall), to remove advertisements, and/or acquire other items such as, for example, reserving a parking space for a period of time.

The account holder may approve and execute the micro-payment through the account holder device via an account holder account smart contract associated with an account holder account and deployed on a transaction account based micro-payment blockchain network. The account holder smart contract may communicate with a directory smart contract to validate the merchant and micro-payment request. The account holder smart contract may record a micro-payment transaction debit on the transaction account based micro-payment blockchain network and notify the content provider system of payment. In response to the payment notification, the content provider system may deliver content to the content script for rendering.

An issuer system (e.g., a financial institution, a transaction account issuer, a credit card company, and/or the like) may communicate with the account holder account smart contract and may access the transaction account based micro-payment blockchain network via a blockchain node. The account holder account smart contract may record a plurality of micro-payment transaction debits and may comprise transaction clearance criteria defining a transaction clearance event. In other words, in response to the transaction clearance criteria being met, the account holder account smart contract may generate a transaction clearance event and notification to the issuer system. In response to the transaction clearance event, the issuer system may aggregate the plurality of micro-payment transaction debits into a single consolidated debit balance internal to the issuer system and may clear the corresponding plurality of micro-payment transaction debits by recording a micro-payment transaction credit corresponding to the cleared consolidated debit balance. In this regard, the transaction costs associated with micro-payment transactions may be reduced by ‘batch’ execution of micro-payment transactions on traditional payment networks.

The process may improve the function of the computer by batching transactions, thereby decreasing network traffic and decreasing processing overhead. Additionally, by transmitting, storing, and accessing data using the processes described herein, the security of the data is improved, which decreases the risk of the computer or network from being compromised. Credit/debit or other types of electronic payments in general carry an overhead cost due to CPU network equipment usage and storage. As long as this cost represents a small fraction of the payment amount, these costs can be absorbed by conventional payment processing network. The same networks tend not to be able to process a transaction efficiently for smaller amounts. Micro-payment transactions use cases also tend to involve large number of transactions, which tend to put an extra burden on the systems processing them. The proposed system mitigates these cost constraints by ledgering these transactions on a blockchain, thus offloading the processing and storage needs from the conventional payment networks, and account receivable, and clearing and settlement systems, while tending to benefit transparency to the involved parties.

The systems, methods, and computer readable mediums (collectively, the “system”) described herein, in accordance with various embodiments, may use a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers (e.g., micro-payment transaction debits, micro-payment transaction credits, account holder account smart contracts, directory smart contracts, etc.) performed through the system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times and the speed of transferring data, initiating purchases, and completing purchases in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of buying requests and purchases by performing cryptographic processes on data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. Further, by syncing data with the involved parties in real time (or near real time), the system may improve data integrity, data confidentiality, and data security, which may also improve the speed of the business process. The system also offers increased reliability and fault tolerance over traditional databases (e.g., relational databases, distributed databases, etc.) as each node may operate with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, and U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, and U.S. application Ser. No. 15/943,271 titled FRAUD MANAGEMENT USING A DISTRIBUTED DATABASE and filed on Apr. 2, 2018, the contents of which are each incorporated by reference in its entirety.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

With reference to FIG. 1, a system 100 for transaction account based micro-payments is depicted according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing. System 100 based on a blockchain, as described herein, may simplify and automate micro-payment transfers and related processes by using the blockchain as a distributed and tamper-proof data store. Transparency is very high for various embodiments using a federated or public blockchain since validation is performed, for example, using data stored by a decentralized autonomous organization (DAO) instead of a specific financial institution.

In various embodiments and with reference to FIG. 1, system 100 may comprise an account holder 101 (e.g., a user), an end user device 200 (e.g., an account holder device), a merchant system 300, an issuer system 500 (e.g., a financial institution system), and/or a transaction account based micro-payment blockchain network 400 (i.e. a blockchain network). Blockchain network 400 may be in electronic communication with end user device 200, merchant system 300, and/or issuer system 500, via one or more blockchain nodes, as discussed further herein.

In various embodiments, blockchain network 400 is configured to maintain a blockchain. Blockchain network 400 may be a peer-to-peer network that is private, federated, and/or public in nature (e.g., ETHEREUM®, Bitcoin, Hyperledger® Fabric, etc.). Federated and private networks may offer improved control over the content of the blockchain and public networks may leverage the cumulative computing power of the network to improve security. Blockchain network 400 may comprise various blockchain nodes (e.g., consensus participants) in electronic communication with each other, as discussed further herein. Each blockchain node may comprise a computing device configured to write blocks to the blockchain and validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., iPhone®, BlackBerry®, Android®, etc.) tablets, wearables (e.g., smart watches and smart glasses), Internet of things (JOT) devices or any other device capable of receiving data over network. Each computing device may run applications to interact with blockchain network 400, communicate with other devices, perform crypto operations, and otherwise operate within system 100. Computing devices may run a client application that can be a thin client (web), hybrid (i.e. web and native, such as iOS and Android), or native application to make API calls to interact with the blockchain, such as a web3 API compatible with blockchain databases maintained by ETHEREUM®.

In various embodiments, blockchain network 400 may include a distributed ledger that maintains records in a readable manner and that is resistant to tampering. Blockchain network 400 may be based on blockchain technologies such as, for example, ETHEREUM®, Open Chain, Chain Open Standard, HYPERLEDGER® Fabric, CORDA CONNECT®, INTEL® Sawtooth, etc. Blockchain network 400 may comprise a ledger of interconnected blocks containing data. The ledger of interconnecting blocks containing data may be interconnected by reference to the previous block. Each block may include a link to the previous block and may include a timestamp. Each block may hold one or more of micro-payment transaction clearance credits, micro-payment transaction debits, account holder account smart contracts, directory smart contracts, merchant payment addresses, transaction addresses, and/or the like. When implemented in support of system 100, blockchain network 400 may serve as an immutable log of transactions in system 100. Blockchain network 400 may be maintained on various blockchain nodes (e.g., blockchain node 540, a second blockchain node, a third blockchain node, etc.) in the form of copies or partial copies of the blockchain network, as discussed further herein. Blocks (e.g., including micro-payment transaction clearance credits, micro-payment transaction debits, account holder account smart contracts, directory smart contracts, merchant payment addresses, transaction addresses, etc.) may be written to blockchain network 400 by establishing consensus between the blockchain nodes based on proof of work, proof of stake, practical byzantine fault tolerance, delegated proof of stake, or other suitable consensus algorithms. In this regard, data can be added to the blockchain by establishing consensus between network participants (e.g., the blockchain nodes).

A blockchain address may be uniquely assigned to each blockchain node or participant to function as a unique identifier for each participant in blockchain network 400. For example, each participant may register with blockchain network 400, and/or an existing trust participant (e.g., identity provider), and may be assigned and provided a private key and public key pair. In various embodiments, blockchain network 400 may use a Hierarchical Deterministic (HD) solution to enable the creation of one or more child keys from one or more parents keys in a hierarchy. Each child key may be assigned to a participant in blockchain network 400. For example, blockchain network 400 may use BIP32, BIP39, and/or BIP44 to generate an HD tree of public addresses.

In various embodiments, blockchain network 400 may host smart contracts, such as account holder account smart contract 410 and directory smart contract 420, that may autonomously govern the logging and/or validation of registration credentials, micro-payment transaction credits and debits, wallet transaction address and merchant payment address pairs, and/or the like by supporting execution and/or recording of data to blockchain network 400. Smart contracts 410 and 420 may control the end-to-end flow of the system. For example, and as discussed further herein, directory smart contract 420 may be configured to control the process of searching for, registering, and/or propagating to blockchain network 400 user credentials (such as account holder credentials or merchant system credentials) during a registration process; validating received login credentials by matching the merchant payment address of a payment request against stored merchant addresses; and generating and/or transmitting various statuses, confirmations, or the like. Directory smart contract 420 contracts may also be configured to store and maintain a stored data map comprising stored registration data or metadata indicating the position of stored registration data in blockchain network 400 and/or merchant address/account holder account smart contract pairs.

In various embodiments, account holder account smart contract 410 may be configured to store and maintain the account holder registration data along with the stored data map. In various embodiments, account holder account smart contract 410 may also be configured to write the stored registration data to blockchain network 400. Account holder account smart contract 410 may be configured to record micro-payment transaction credits and debits to blockchain network 400. Account holder account smart contract 410 may also be configured to validate merchant payment requests and generate transaction clearance events in response to transaction clearance criteria. Smart contracts 410 and 420 may include a program written in a programming language such as, for example, Solidity, or any other suitable programming language.

In various embodiments and with continued reference to FIG. 1, end user device 200 may enable account holder 101 to interact with system 100 to register for transaction account based micro-payments, view content, complete purchases, and/or the like. End user device 200 may comprise any suitable combination of hardware, software, and/or database components. For example, end user device 200 may comprise at least one computing device in the form of a computer or processor, or a set of computers/processors, although other types of computing units or systems may be used. The processor may be configured to implement various logical operations in response to execution of instructions, for example, instructions stored on a non-transitory, tangible, computer-readable medium, as discussed further herein. For example, end user device 200 may comprise a personal computer, personal digital assistant, cellular phone, smartphone (e.g., IPHONE®, BLACKBERRY®, and/or the like), Internet of things (IoT) device, kiosk, and/or the like. End user device 200 may comprise an operating system, such as, for example, a WINDOWS® mobile operating system, an ANDROID® operating system, APPLE® IOS®, a BLACKBERRY® operating system, and the like.

In various embodiments, end user device 200 may comprise a browser or app user interface (UI) 210, a plugin 220 configured to communicate with blockchain network 400 including account holder account smart contract 410 and directory smart contract 420, and/or a blockchain wallet 230. The aforesaid elements may be in direct logical communication with each other via a bus, network, and/or through any other suitable means, or may be individually connected. In various embodiments, browser or app UI 210 may comprise a web browser (e.g., MICROSOFT INTERNET EXPLORER®, GOOGLE CHROME®, etc.), an application, a micro-app or mobile application (e.g., downloaded via APPLE® APP STORE®, GOOGLE PLAY®, etc.), or the like, configured to allow a user, such as account holder 101 to access and interact with merchant system 300, issuer system 500 and/or blockchain network 400.

For example, the account holder 101 may interact with merchant system 300, via end user device 200, to receive content, purchase items, and/or the like. End user device 200 may be in electronic communication with merchant system 300, issuer system 500 and/or blockchain network 400, and may comprise any suitable hardware, software, and/or database components capable of sending, receiving, and storing data. End user device 200 may comprise software components installed on end user device 200 and configured to allow an account holder 101, to interact with merchant system 300 and/or issuer system 500 via a web page or an internet of things.

In various embodiments and with continued reference to FIG. 1, merchant system 300 may comprise a blockchain software development kit (SDK) 310, a content provider system 320, and/or a paid content script 330. The aforesaid elements may be in direct logical communication with each other via a bus, network, and/or through any other suitable means, or may be individually connected. Merchant system 300 may also include one or more data centers, cloud storages, or the like, and may include software, such as APIs or SDKs, configured to retrieve and write data to the blockchain. In various embodiments, merchant system 300 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, paid content script 330 may be configured to generate a micro-payment request and deliver content from content provider system 320 to end user device 200 in response to a micro-payment transaction executed on blockchain network 400. In various embodiments, blockchain SDK 310 may be configured to provide software, services, and interfaces to enable communications between blockchain network 400 paid content script 330 and content provider system 320. Blockchain SDK 310 may comprise programmatic libraries configured to translate and transmit queries and commands from merchant system 300 to blockchain network 400. For example, blockchain SDK 310 may be configured to receive payment notifications or request transaction confirmations from blockchain network 400 (e.g., account holder account smart contract 410) related to a micro-payment request generated by paid content script 330. Blockchain SDK 310 may comprise one or more merchant-specific cryptographic keys used to perform cryptographic operations. As a further example, and in accordance with various embodiments, blockchain SDK 310 may be configured to translate data retrieved from blockchain network 400 into a format readable by end user device 200, issuer system 500 or merchant system 300, which may include digital signature verification and/or data transformation from a blockchain specific data layout to an application specific data layout.

In various embodiments, issuer system 500 may comprise an internal network 510, a clearing and settlement system 520, an accounts receivable (AR) system 530, a blockchain node 540, an account holder registration system 550 and a merchant registration system 560. Issuer system 500 may comprise any suitable combination of hardware, software, and/or database components. For example, may comprise one or more network environments, servers, computer-based systems, processors, databases, and/or the like. Issuer system 500 may comprise at least one computing device in the form of a computer or processor, or a set of computers/processors, although other types of computing units or systems may be used, such as, for example, a server, web server, pooled servers, or the like. Issuer system 500 may also include one or more data centers, cloud storages, or the like, and may include software, such as APIs, configured to retrieve and write data to the blockchain. In various embodiments, issuer system 500 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, issuer system 500 may comprise or interact with a traditional payment network to facilitate purchases and payments, authorize transactions, and/or settle transactions. For example, internal network 510 may represent existing proprietary networks that presently accommodate transactions for credit cards, debit cards, and/or other types of transaction accounts or transaction instruments. Internal network 510 may be a closed network that is secure from eavesdroppers. In various embodiments, internal network 510 may comprise an exemplary transaction network such as AMERICAN EXPRESS®, VISANET®, MASTERCARD®, DISCOVER®, INTERAC®, Cartes Bancaires, JCB®, private networks (e.g., department store networks), and/or any other payment network. Issuer system 500 and/or internal network 510 may include systems and databases related to financial and/or transactional systems and processes, such as, for example, one or more authorization engines, authentication engines and databases, settlement engines and databases, accounts receivable systems and databases, accounts payable systems and databases, and/or the like. For example, internal network 510 may authorize and settle payment transactions, and maintain transaction account member databases, accounts receivable databases, accounts payable databases, or the like. In various embodiments, internal network 510 may be configured as a central network element or hub to access various systems, engines, and components of issuer system 500.

In various embodiments, internal network 510 may be in communication with a blockchain node 540. Blockchain node 540 may be in electronic communication with blockchain network 400, and may be configured to allow issuer system 500 access to blockchain network 400, account holder account smart contract 410, and directory smart contract 420. Blockchain node 540 may be configured to maintain a copy and/or partial copy of blockchain network 400, write to and/or retrieve data and blocks from blockchain network 400, validate blocks of blockchain network 400, and/or propagate writes to account holder account smart contract 410 and directory smart contract 420 to blockchain network 400. Blockchain node 540 may communicate with one or more blockchain nodes (e.g., a second blockchain node, a third blockchain node, etc.) to validate and write blocks to blockchain network 400, and to establish consensus between the blockchain nodes based on proof of work, proof of stake, practical byzantine fault tolerance, delegated proof of stake, or other suitable consensus algorithms.

Blockchain node 540 may comprise one or more computing devices, such as, for example a computer or processor, or a set of computers, processor, and/or application specific integrated circuits (ASICs), although other types of computing units or system may also be used. Exemplary computing devices may include servers, pooled servers, laptops, notebooks, hand held computers, personal digital assistants, cellular phones, smart phones (e.g., IPHONES, BLACKBERRY®, ANDROID®, etc.), tablets, wearables (e.g., smart watches, smart glasses, etc.), Internet of things (IoT) devices, or any other device capable of receiving data over a network. Blockchain node 540 may run applications to interact with blockchain network 400, communicate with other devices, perform crypto operations, and otherwise operate within issuer system 500. For example, blockchain node 540 may run a client application that can be a thin client (web), a hybrid (i.e., web and native, such as iOS and ANDROID®), or a native application to make application programming interface (API) calls to interact with blockchain network 400, such as a web3 API compatible with blockchain databases maintained by ETHEREUM®.

Referring now to FIGS. 2-5, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 2-5, but also to the various system components as described above with reference to FIG. 1.

With reference to FIG. 2, a process flow 2000 for account holder registration in a transaction account based micro-payment system is illustrated according to various embodiments. Account holder 101 or end user device 200 accesses a card account portal of account holder registration system 550 (step 2002). Account holder registration system 550 may prompt the end user device 200 for account holder credentials such as a username (e.g., account holder identifier, etc.) and password, a biometric input, or the like. Account holder registration system 550 may validate the account holder credentials using any suitable technique. For example, Account holder registration system 550 may validate the account holder credentials by comparing the input against stored account holder credentials.

In various embodiments, account holder registration system 550 prompts end user device 200 for the blockchain public keys (e.g., a blockchain address or a transaction address) from blockchain wallet 230 to be associated with an account holder account smart contract 410. The end user device 200 may transmit the blockchain transaction address to be associated with the account holder account smart contract 410 (step 2004). In various embodiments, the association between the account holder account smart contract and the blockchain public keys is a one to one association. Account holder registration system 550 may notify internal network 510 in response to receiving the transaction address (step 2006). Internal network 510 may store the transaction address and associate the address with the account holder account, for example, by linking the transaction address and an account holder identification number (step 2008). Internal network 510 may generate an account holder account smart contract 410 associated on a one to one basis with the transaction address and pass the account holder account smart contract 410 to blockchain node 540 (step 2010). Blockchain node 540 may write the account holder account smart contract 410 to the blockchain network 400 (step 2012). Internal network 510 may also update directory smart contract 420 via blockchain node 540 to indicate an active link between the account holder account, transaction address, and account holder account smart contract (step 2014). Blockchain node 540 may write an account holder address/account holder account smart contract address pair to the directory smart contract (step 2016).

With reference to FIG. 3, a process flow 3000 for merchant registration in a transaction account based micro-payment system is illustrated, according to various embodiments. Merchant system 300 accesses a merchant account portal of merchant registration system 560 (step 3002). Merchant registration system 560 may prompt the merchant system 300 for merchant credentials such as a username (e.g., merchant identifier, etc.) and password, a biometric input, or the like. Merchant registration system 560 may validate the merchant credentials using any suitable technique. For example, merchant registration system 560 may validate the merchant credentials by comparing the input against stored merchant credentials such as the merchant identifier.

In various embodiments, merchant registration system 560 prompts merchant system 300 for the blockchain public keys (e.g., a blockchain payment address or a transaction address) such as from blockchain SDK 310 to be associated with a directory smart contract 420. Merchant system 300 may transmit the payment address to be associated with the directory smart contract 420 (step 3004). In various embodiments, the association between the directory smart contract 420 and the merchant payment address is a one to one association. In various embodiments, the association between the directory smart contract 420 and the merchant payment address is a one to many association. In this regard, directory smart contract 420 may comprise a plurality of payment addresses associated with an individual merchant and/or a plurality of merchants with each of the plurality of merchants having one or more payment addresses associated therewith. Merchant registration system 560 may notify internal network 510 in response to receiving the payment address (step 3006). Internal network 510 may store the payment address and associate the address with the merchant account, for example, by linking the payment address and a merchant identification number (step 3008). Internal network 510 may generate or update a directory smart contract 420 associated to contain the payment address via blockchain node 540 (step 3010). Blockchain node 540 may write the directory smart contract 420 and/or directory smart contract updates to the blockchain network 400 (step 3012). In this regard, the directory smart contract 420 maintains links between active payment addresses and merchants registered via issuer system 500.

With reference now to FIG. 4, a process flow 4000 for a transaction account based micro-payment system is illustrated in accordance with various embodiments. App UI 210 may receive a command to navigate to paid content (step 4002). The app UI 210 of end user device 200 may request access to the paid content from merchant system 300 and may load paid content script 330 from merchant system 300 (step 4004). The paid content script 330 may request an account holder account validation via the blockchain SDK 310 of merchant system 300 such as, for example, by passing a transaction address generated by blockchain wallet 230 of end user device 200 to the blockchain SDK 310 (step 4006). Blockchain SDK 310 may invoke, via issuer system 500, directory smart contract 420 on blockchain network 400 in response to the account holder account validation request (step 4008). Directory smart contract 420 may return an account holder account smart contract transaction address associated with the transaction address generated by blockchain wallet 230 to the blockchain SDK 310 (step 4010). The blockchain SDK 310 may confirm the validity of the account holder account smart contract (step 4012). In various embodiments, validity may be confirmed where there is a one to one association between the transaction address generated by blockchain wallet and the account holder account smart contract 410 as recorded in the directory smart contract 420.

In various embodiments, the paid content script 330 may pass the account holder account smart contract transaction address to the content provider system 320 of merchant system 300 (step 4014). The content provider system 320 may register the account holder account smart contract transaction address for events (step 4016) such as, for example, content delivery on notification of payment or validation for a plurality of transactions. Paid content script 330 may prompt the app UI 210 for payment (step 4018). For example, paid content script 330 may transmit a micro-payment request including a merchant payment address from a merchant system 300. In various embodiments, app UI 210 may prompt an account holder 101 to accept or validate the micro-payment request or may be configured to accept micro-payment requests automatically based on a set of acceptance criteria (step 4020). In various embodiments, the acceptance criteria may comprise app UI 210 settings, a whitelist, a blacklist, or other rule and/or the like.

In various embodiments, end user device 200 app UI 210 may receive the micro-payment request from paid content script 330 and instruct plugin 220 to process the micro-payment request (step 4022). Plugin 220 may call blockchain wallet 230 and request a private key associated with the transaction address associated with the account holder account smart contract 410 (step 4024). Blockchain wallet 230 may provide the private key to the plugin 220 in response to the request (step 4026) and the plugin 220 may sign the payment transaction (step 4028). Plugin 220 may invoke, via issuer system 500, account holder account smart contract 410 in response to the signed payment transaction (step 4030). Account holder account smart contract 410 may call directory smart contract 420 and pass the payment address of the micro-payment request for validation (step 4032). In various embodiments, directory smart contract 420 may compare the payment address of the micro-payment request with the list of valid merchant transaction addresses and return a validation message to the account holder account smart contract 410 (step 4034). In response, account holder account smart contract 410 may write one or more micro-payment transaction debits corresponding to the transaction address and the payment address (step 4023). In this regard, a plurality of micro-payment transaction debits may be added to a ledger associated with the account holder account smart contract and may thereby be associated with an individual account holder account of issuer system 500. In response to recording the micro-payment transaction debit associated with the payment address of the micro-payment request, account holder account smart contract 410 may notify content provider system 320 of the completed micro-payment (step 4038). Content provider system 320 may deliver content to paid content script 330 in response to the notification (step 4040). Paid content script 330 may receive the content and render the content for app UI 210 (step 4042).

In various embodiments and with reference now to FIG. 5, a process flow 5000 for a transaction clearance event in a transaction account based micro-payment system is illustrated. Account holder account smart contract 410 may generate a transaction clearance event based on transaction clearance criteria and notify blockchain node 540 of the event (step S002). In various embodiments, transaction clearance criteria may comprise an individual micro-payment threshold, an aggregate micro-payment threshold, a transaction volume or transaction rate threshold, or a time based threshold. For example, an individual micro-payment threshold may comprise a currency amount for any given micro-payment transaction. The individual micro-payment threshold may comprise instructions of the form ‘generate a transaction clearance event when any single micro-payment transaction exceeds X units of a currency’ and/or the like. In a related example, an aggregate micro-payment threshold may comprise a currency amount for an aggregated plurality of micro-payments. The aggregate micro-payment threshold may comprise instructions of the form ‘generate a transaction clearance event when the sum of a plurality of micro-payment transactions exceeds Y units of a currency’ and/or the like. In another example, a transaction volume threshold may comprise instructions of the form ‘generate a transaction clearance event when a count of micro-payment transactions exceeds X’ or of the form ‘generate a transaction clearance event when a count of micro-payment transactions exceeds X within Y units of time’ and/or the like. In a further example, a time based threshold may comprise instructions of the form ‘generate a transaction clearance event every X units of time’ or ‘generate a transaction clearance event if more than Y units of time have elapsed since a prior transaction clearance event’ and/or the like.

In response to the notification, blockchain node 540 may query the account holder account smart contract 410 for the micro-payment transaction debits and determine the account holder account associated therewith (step S004). The account holder account smart contract 410 may report the plurality of micro-payment transaction debits to the blockchain node 540 (step S006). Blockchain node 540 may aggregate the plurality of micro-payment transaction debits based on the association with the account holder account smart contract and trigger a clearing process on internal network 510 (step S008). In various embodiments, blockchain node 540 may generate an account holder debit transfer balance based on the aggregated plurality of micro-payment transaction debits and internal network 510 move the balance to AR system 530 (step S010). AR system 530 may write the account holder debit transfer balance as an account holder debit balance associated with the account holder account and may pass the account holder debit balance to clearing and settlement system 520 as part of an issuer system 500 clearing process (step S012). In various embodiments, clearing and settlement system 520 may associate a merchant payable credit with a merchant identifier or merchant account of issuer system 500 based on the account holder debit balance. In response to moving the account holder debit transfer balance to the AR system 530, internal network 510 may generate a micro-payment transaction clearance credit based on the account holder debit transfer balance and/or the account holder debit balance recorded by the AR system 530. Internal network 510 may pass the micro-payment transaction credit to the account holder account smart contract 410 via blockchain node 540 for association with the related micro-payment transaction account (step S014).

The disclosure and claims do not describe only a particular outcome of a transaction account based micro-payment system, but the disclosure and claims include specific rules for implementing the outcome of a transaction account based micro-payment system and that render information into a specific format that is then used and applied to create the desired results of a transaction account based micro-payment system, as set forth in McRO, Inc. v. Bandai Namco Games America Inc. (Fed. Cir. case number 15-1080, Sep. 13, 2016). In other words, the outcome of a transaction account based micro-payment system can be performed by many different types of rules and combinations of rules, and this disclosure includes various embodiments with specific rules. While the absence of complete preemption may not guarantee that a claim is eligible, the disclosure does not sufficiently preempt the field of a transaction account based micro-payment system at all. The disclosure acts to narrow, confine, and otherwise tie down the disclosure so as not to cover the general abstract idea of just a transaction account based micro-payment system. Significantly, other systems and methods exist for a transaction account based micro-payment system, so it would be inappropriate to assert that the claimed invention preempts the field or monopolizes the basic tools of a transaction account based micro-payment system. In other words, the disclosure will not prevent others from a transaction account based micro-payment system, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

The various communications discussed herein may be performed using a network. As used herein, the term “network” may further include any cloud, cloud computing system or electronic communications system or method that incorporates hardware and/or software components. Communication among the parties may be accomplished through any suitable communication channels, such as, for example, a telephone network, an extranet, an intranet, Internet, point of interaction device (point of sale device, personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g., IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. Asymmetric encryption in particular may be of use in signing and verifying signatures for blockchain crypto operations.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

In various embodiments, the system and various components may integrate with one or more smart digital assistant technologies. For example, exemplary smart digital assistant technologies may include the ALEXA system developed by AMAZON®, GOOGLE HOME®, APPLE® HOMEPODO, and/or similar digital assistant technologies. AMAZON® ALEXA, GOOGLE HOME®, and APPLE® HOMEPODO, may each provide cloud-based voice activation services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPODO systems may receive voice commands via its voice activation technology, and activate other functions, control smart devices, and/or gather information. For example, the smart digital assistant technologies may be used to interact with music, emails, texts, calling, question answering, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPODO systems may also allow the user to access information about eligible transaction accounts linked to an online account across all digital assistant-enabled devices.

The phrases consumer, customer, user, account holder, account affiliate, cardmember, account holder or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit

Computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); JAVA® 2 Complete, various authors, (Sybex 1999); Deborah Ray and Eric Ray, Mastering HTML 4.0 (1997); and Loshin, TCP/IP Clearly Explained (1997) and David Gourley and Brian Tatty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit,” “debit” or “debiting” refers to either causing the debiting of a stored value or prepaid card-type financial account, or causing the charging of a credit or charge card-type financial account, as applicable.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user,” “consumer,” “customer,” “cardmember,” “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 2-5 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-5, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Phrases and terms similar to a “party” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account,” “account number,” “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000.” The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Therefore, the following is claimed:

1. A system, comprising:
a client device comprising a processor and a memory, the client device being associated with a user registered to participate in a micro-payment transaction program; and
machine-readable instructions stored in the memory that, when executed by the processor, cause the client device to at least:
receive, via a paid content script, a micro-payment request from a provider computing device associated with a provider entity, the micro-payment request including a provider payment address and requesting payment for paid content requested by the client device and provided by the provider entity;
sign a payment transaction for payment associated with the micro-payment request using a private key associated with the user;
invoke an account holder account smart contract on a distributed ledger to initiate payment for the sign contract, the account holder account smart contract being invoked based at least in part on the signed payment transaction and the provider payment address;
receive the paid content from the provider entity in response to a successful payment for the paid content via the micro-payment transaction program; and
cause the paid content to be rendered on a display of the client device.

2. The system of claim 1, wherein the provider entity is a registered participant of the micro-payment transaction program.

3. The system of claim 1, wherein the machine-readable instructions further cause the client device to at least receive a paid content request for the paid content provided by the provider entity, the paid content request being received via a user interaction with a user interface rendered on the display of the client device.

4. The system of claim 3, wherein the machine-readable instructions further cause the client device to at least execute the paid content script associated with a provider entity in response to receiving the paid content request.

5. The system of claim 1, wherein the machine-readable instructions further cause the client device to at least send, via the paid content script, an account holder verification request to the provider computing device, the account holder verification request comprising a user transaction address associated with the user.

6. The system of claim 5, wherein the private key is part of a key-pair comprising the private key and a public key, the public key corresponding to a user transaction address.

7. The system of claim 6, wherein the user transaction address corresponds to a location for the account holder account smart contract.

8. A method, comprising:
receiving a registration request from a client device associated with a user, the registration request requesting participation in a micro-payment transaction program and comprising a transaction address associated with a transaction account of the user;
generating an account holder account smart contract associated with the transaction account of the user, the account holder account smart contract being generated to validate a payment requesting entity and a payment request via the micro-payment transaction program and to generate a transaction clearance event associated with a plurality of micro-payments;
writing the account holder account smart contract to a distributed ledger; and
updating a directory smart contract stored on the distributed ledger, the directory smart contract being updated to indicate an active link between the transaction account, the transaction address, and the account holder account smart contract.

9. The method of claim 8, wherein the registration request comprises a first registration request, and further comprising receiving a second registration request from a provider computing device associated with a provider entity, the second registration request requesting participation in the micro-payment transaction program and comprising a payment address associated with a payment account of the provider entity.

10. The method of claim 9, further comprising:
generating the directory smart contract to indicate a relationship between the payment address and the provider entity; and
writing the directory smart contract to the distributed ledger.

11. The method of claim 9, further comprising:
updating the directory smart contract to indicate a relationship between the payment address and the provider entity.

12. The method of claim 8, further comprising:
receiving a notification of the transaction clearance event via the account holder account smart contract;
identifying a plurality of micro-payment transaction debits associated with the transaction address based at least in part on querying the account holder account smart contract; and
initiating a clearance process associated with the plurality of micro-payment transaction debits.

13. The method of claim 12, further comprising aggregating the plurality of micro-payment transaction debits to generate a debit transfer balance.

14. The method of claim 8, wherein the account holder account smart contract is generated to include transaction clearance criteria, the transaction clearance event is generated in response to the transaction clearance criteria, and the transaction clearance criteria comprises at least one of an individual micro-payment threshold, an aggregate micro-payment threshold, a transaction volume threshold, or a time based threshold.

15. A non-transitory, computer-readable medium, comprising machine-readable instructions that, when executed by a processor of a computing device associated with a provider entity, cause the computing device to at least:
receive an account holder validation request associated with an account holder requesting access to paid content provided by the provider entity, the account holder validation request comprising an account holder transaction address associated with the account holder, the account holder being a registered participant in a micro-payment transaction program;
invoke a directory smart contract stored on a distributed ledger in response to receiving the account holder validation request;
determine an account holder smart contract transaction address associated with the account holder transaction address based at least in part on a result received from the directory smart contract;
confirm a validity of an account holder smart contract stored on the distributed ledger based at least in part the account holder smart contract transaction address and the account holder transaction address; and
register the account holder smart contract transaction address for one or more events associated with the paid content.

16. The non-transitory, computer-readable medium of claim 15, wherein the one or more events comprise at least one of a delivery of the paid content on notification of payment for the paid content or a validation of a plurality of transactions.

17. The non-transitory, computer-readable medium of claim 15, wherein the directory smart contract is executed by at least one computing node of a plurality of computing nodes of a distributed ledger network of the distributed ledger.

18. The non-transitory, computer-readable medium of claim 15, wherein the machine-readable instructions, when executed by the processor, further cause the computing device to at least:
receive payment notification from the account holder smart contract, the payment notification indicating a completed micro-payment by the account holder; and
provide the paid content to a client device of the account holder.

19. The non-transitory, computer-readable medium of claim 15, wherein the machine-readable instructions, when executed by the processor, further cause the computing device to at least:
determine a payment address associated with a payment account of the provider entity; and
send a registration request to a program entity to become another registered participant in the micro-payment transaction program, the registration request comprising the payment address of the provider entity.

20. The non-transitory, computer-readable medium of claim 19, wherein the payment address corresponds to a location on the distributed ledger.
